(19) United States
(12) Patent Application Publication
(10) Pub. No.: US 2026/0321586 A1
(43) Pub. Date: Oct. 15, 2026

(54) ELECTRODE STACK FOR ALKALINE ELECTROCHEMICAL CELLS

(71) Applicant: Energizer Brands, LLC, St. Louis, MO (US)

(72) Inventor: Robert P. Johnson, Lakewood, OH (US)

(21) Appl. No.: 19/142,597

(22) PCT Filed: Dec. 13, 2023
(86) PCT No.: PCT/US2023/083828

§ 371 Date: Jun. 23, 2025

Related U.S. Application Data
(60) Provisional application No. 63/387,441, filed on Dec. 14, 2022.

(51) Int. Cl. H01M 4/24; H01M 4/02; H01M 50/107

(52) U.S. Cl. CPC H01M 4/244; H01M 50/107; H01M 2004/021; H01M 2004/027; H01M 2004/028

(57) ABSTRACT

In some embodiments, an electrochemical cell (200) may include a container; electrodes disposed within the container and including a first set of electrodes and a second set of electrodes, wherein the first set of electrodes includes one or more first electrodes (207) and the second set of electrodes includes one or more second electrodes (205), and wherein the one or more first electrodes and the one or more second electrodes alternate within the stack such that the first electrodes are not in contact with each other and the second electrodes are not in contact with each other; a set of separators (203, 204) including one or more separators disposed between the first set of electrodes and the second set of electrodes; an electrolyte solution disposed within the container; and a current collector disposed within the container.

### CROSS-REFERENCE TO RELATED APPLICATIONS

This patent application claims priority to U.S. Provisional Appl. Ser. No. 63/387,441, filed Dec. 14, 2022, which is incorporated herein by reference in its entirety.

### TECHNICAL FIELD

The present disclosure relates generally to alkaline batteries, and more particularly to alkaline batteries with electrodes arranged in a stacked configuration.

### BACKGROUND

Alkaline electrochemical cells are commercially available in cell sizes commonly known as LR6 (AA), LR03 (AAA), LR14 (C) and LR20 (D). The cells have a cylindrical shape that must comply with the dimensional standards that are set by organizations such as the International Electrotechnical Commission. The electrochemical cells are utilized by consumers to power a wide range of electrical devices, for example, clocks, radios, toys, electronic games, film cameras generally including a flashbulb unit, as well as digital cameras. Such electrical devices possess a wide range of electrical discharge conditions, such as from low drain (“low rate”) to relatively high drain (“high rate”). Due to the increased use of high drain devices, a need exists for a battery having improved high rate discharge properties. However, improvements to high rate discharge properties may negatively affect low rate discharge properties, and vice-versa.

### BRIEF SUMMARY

Various embodiments are directed to an electrochemical cell comprising a container having a closed bottom end and an open top end; a closure assembly secured to and closing the open top end of the container; a stack comprising two or more tablet-shaped electrodes disposed within the container, wherein the two or more tablet-shaped electrodes comprise a set of one or more first electrodes and a set of one or more second electrodes, and wherein the one or more first electrodes and the one or more second electrodes alternate within the stack; a set of separators comprising one or more separators disposed between each electrode within the stack; an electrolyte solution disposed within the container; and a current collector disposed within the container.

In certain embodiments, the one or more separators of the electrochemical cell comprise at least one first separator and at least one second separator, and wherein the at least one first separator has a different composition than the at least one second separator. In certain embodiments, the one or more first electrodes are anodes comprising a zinc material. In various embodiments, the one or more second electrodes are cathodes comprising a manganese dioxide material. In certain embodiments, the electrochemical cell further comprises a second electrode positioned on a bottom end of the stack, adjacent the closed bottom end of the container. In various embodiments, the electrochemical cell further comprises a second electrode positioned on a top end of the stack, adjacent the open top end of the container. In certain embodiments, each of the one or more second electrodes defines a center opening extending therethrough and each of the one or more second electrodes further comprises an insulating sleeve lining the center opening; and wherein the current collector is a current collector nail extending through a center of the insulating sleeve. In various embodiments, at least one of the one or more separators are secured to each of the one or more first electrodes and wherein the current collector nail extends through a center of the at least one separator secured to each of the one or more first electrodes to electrically connect with active material of the one or more first electrodes. In some embodiments, each of the one or more first electrodes comprises a gasket electrically insulating the active material of the one or more first electrodes from the container, and wherein the at least one of the one or more separators are secured to the gasket. In various embodiments, each of the one or more second electrodes comprises at least one separator; and wherein the insulating sleeve of each of the one or more second electrodes comprises one or more grommets securing the at least one separator of each second electrode.

Certain embodiments are directed to an anode for an electrochemical cell comprising an anode active material composition; an insulating gasket having open ends, wherein the insulating gasket surrounds the anode active material; and an ionically-permeable separator disk secured onto each of the open ends of the insulating gasket to seal the anode active material within the insulating gasket.

In certain embodiments, the anode active material comprises: particulate zinc suspended within an electrolyte gel; particulate zinc oxide; and dissolved zinc oxide. In various embodiments, the insulating gasket comprises a polymeric material. In certain embodiments, the insulating gasket comprises: a cylindrical sleeve having a first open end and an opposite second open end; a first grommet secured onto the first open end, wherein a first separator is secured onto the first grommet; and a second grommet secured onto the second open end, wherein a second separator is secured onto the second grommet. In certain embodiments, the first separator is adhered onto the first grommet and the second separator is adhered onto the second grommet.

Various embodiments are directed to a cathode comprising a cathode active material composition formed in an annular shape defining a center opening extending therethrough; a first ion-permeable separator sheet on a first side of the cathode active material composition; a second ion-permeable separator sheet on a second side of the cathode active material composition; an insulating sleeve positioned within the center opening, wherein: a first end of the insulating sleeve extends beyond the first ion-permeable separator sheet and secures the first ion-permeable separator sheet onto the first side of the cathode active material composition; and a second end of the insulating sleeve extends beyond the second ion-permeable separator sheet and secures the second ion-permeable separator sheet onto the second side of the cathode active material composition.

In certain embodiments, the first ion-permeable separator sheet and the second ion-permeable separator sheet are planar and a sidewall of the cathode active material composition extending between the first side and the second side is exposed. In various embodiments, the insulating sleeve comprises a first grommet and a second grommet secured to the first grommet within the cylindrical open center of the cathode active material composition.

### BRIEF SUMMARY OF THE DRAWINGS

Having thus described the disclosure in general terms, reference will now be made to the accompanying drawings, which are not necessarily drawn to scale, and wherein:

FIG. 1 is a cross-sectional, elevational view of an example alkaline electrochemical cell;

FIG. 2A is a cross-sectional, elevational view of an example alkaline electrochemical cell with a stacked configuration of electrodes in accordance with some embodiments;

FIG. 2B is an x-ray image of an electrochemical cell having a stacked electrode tablet configuration in accordance with some embodiments;

FIG. 3A is a cross-sectional, exploded view of an example alkaline electrode set for use within a stacked configuration of electrodes in an electrochemical cell in accordance with some embodiments;

FIG. 3B is a cross-sectional, exploded view of an example cathode tablet in accordance with some embodiments;

FIGS. 4A-4B are cross-sectional exploded views of components of an example anode tablet in accordance with some embodiments;

FIG. 4C is a cross-sectional exploded view of components of an example anode tablet in accordance with some embodiments;

FIG. 5 is a table of example estimates for electrochemical cell properties with stacked electrode configurations in accordance with some embodiments;

FIG. 6 is a table of example material compositions of electrochemical cells with stacked electrode configurations in accordance with some embodiments;

FIG. 7 is a flow chart of an example method of manufacturing an electrochemical cell in accordance with some embodiments; and

FIG. 8 is another flow chart of an example method of manufacturing an electrochemical cell in accordance with some embodiments.

### DETAILED DESCRIPTION AND DISCUSSION

Various embodiments now will be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item. For example, “an organic additive” may refer to two or more organic additives.

To the extent they are not explicitly mutually inconsistent, each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths, hundredths, thousandths, ten-thousandths, and hundred-thousandths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 7-10%, 5.1%-9.9%, and 5.01%-9.99%. As another example, “0.00001-1 M” includes 0.00005-0.0001 M and 0.001-0.01 M.

As used herein, “about” in the context of a numerical value or range means within ±10% of the numerical value or range recited or claimed.

As used herein, “metal additive” refers to a metal-containing compound which is added to the electrolyte and/or cathode. Examples are metal salts and metal oxides. As used herein, “metal ion” refers to an ion of any element which may be considered a metal, including, but not limited to, metals, transition metals (any element in groups 3-12 of the periodic table, particularly groups 4-11), lanthanides, actinides, alkaline earth metals, and alkali metals. “Metal salt” refers to any salt formed from a metal ion. “Metal oxide” refers to any compound comprising a metal ion and oxygen in an oxidation state of −2. Examples of metals suitable for the metal salts, metal oxides, and metal ions of the current invention include magnesium (Mg), barium (Ba), nickel (Ni), copper (Cu), aluminum (Al), and cerium (Ce).

As used herein, “improvement” with respect to specific capacity generally means that the specific capacity is increased. Generally, an “improvement” of a property or metric of performance of a material or electrochemical cell means that the property or metric of performance differs (compared to that of a different material or electrochemical cell) in a manner that a user or manufacturer of the material or cell would find desirable (e.g., costs less, lasts longer, provides more power, more durable, easier or faster to manufacture, etc.).

As used herein, “specific capacity” refers to the total amount of charge in an electrochemical cell when discharged at a particular rate. This is typically measured in ampere hours.

As used herein, “run-time” refers to the length of time that an electrochemical cell will be able to provide a useful voltage level or a voltage above an end point voltage.

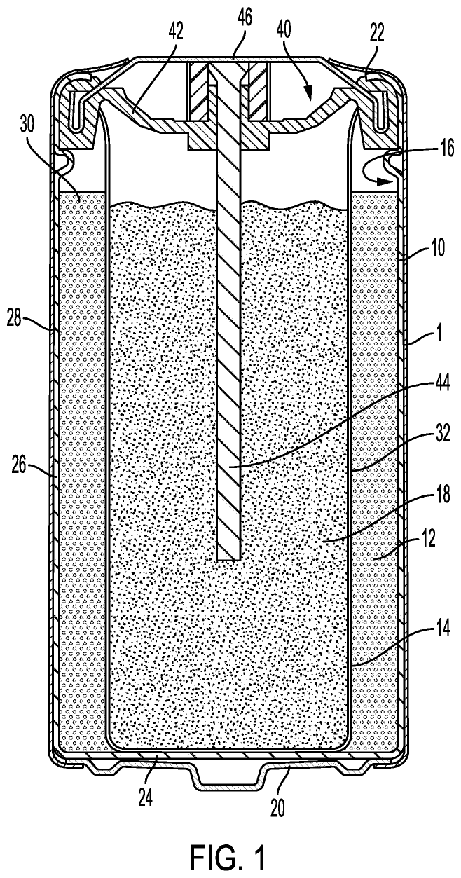

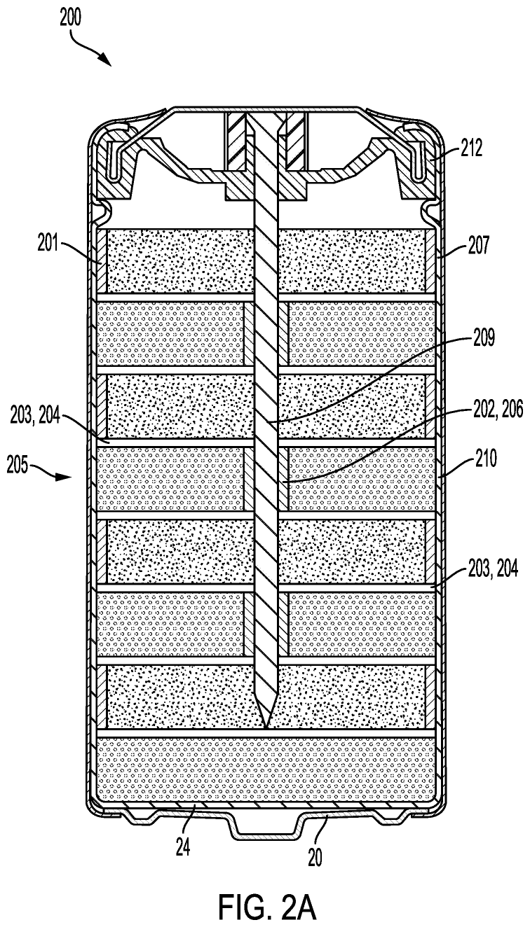

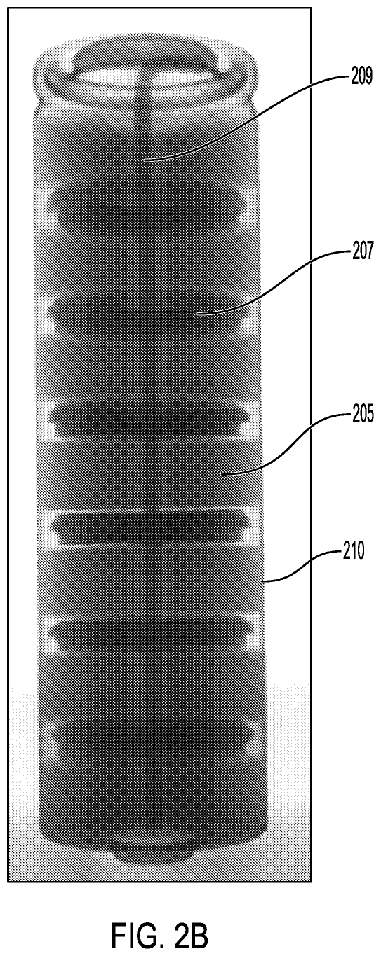

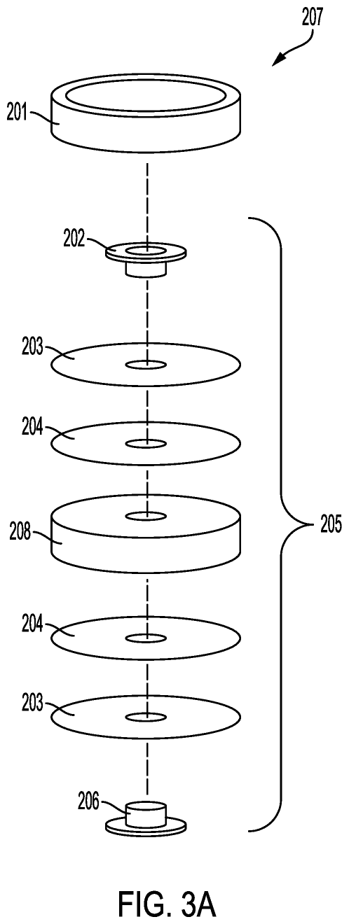

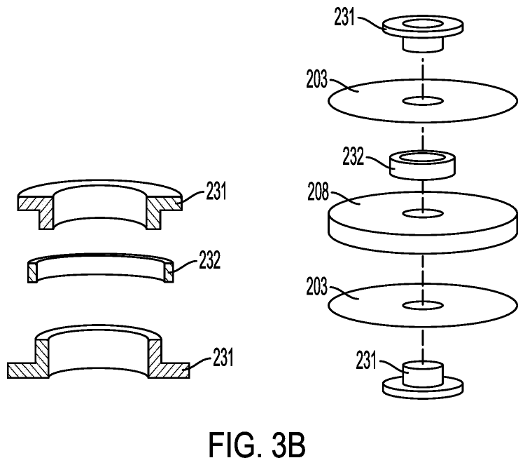

The embodiments will be better understood by reference to the figures, which show various embodiments of a cylindrical primary electrochemical cell in elevational cross-section. FIG. 1 shows an example primary electrochemical cell having a nail-type or bobbin-type construction and dimensions comparable to a conventional LR6 (AA) size alkaline cell. FIGS. 2A-2B and 3A-3B provide details of an alternative arrangement in which the electrodes are configured in a stacked tablet configuration. It will be understood that the embodiments described herein apply to both Alkaline (Zn/MnO₂) and Alkaline-P (Zn/MnO₂+other) primary cell chemistries. The materials and designs for the components of the electrochemical cells illustrated in the figures are for the purposes of illustration, and other materials and designs may be substituted, including secondary electrochemical cell chemistries. The described, non-limiting embodiment is directed to an alkaline electrochemical cell comprising manganese dioxide in the cathode as an active material.

In FIG. 1, an electrochemical cell 1 is shown, including a container or can 10 having a closed bottom end 24, an open top end 22 and a sidewall 26 (e.g., a cylindrical sidewall) there between. The closed bottom end 24 includes a terminal cover 20 including a protrusion. The can 10 has an inner wall 16. In the embodiment, a positive terminal cover 20 is welded or otherwise attached to the bottom end 24. In one embodiment, the terminal cover 20 can be formed with plated steel for example with a protruding nub at its center region. Container 10 can be formed of a metal, such as steel, preferably plated on its interior with nickel, cobalt and/or other metals or alloys, or other materials, possessing sufficient structural properties that are compatible with the various inputs in an electrochemical cell. A label 28 can be formed about the exterior surface of container 10 and can be formed over the peripheral edges of the positive terminal cover 20 and negative terminal cover 46, so long as the negative terminal cover 46 is electrically insulated from container 10 and positive terminal 20.

Disposed within the container 10 are a first electrode 18 (e.g., an anode) and second electrode 12 (e.g., a cathode) with a separator 14 therebetween. First electrode 18 is disposed within the space defined by separator 14 and closure assembly 40 secured to and closing the open end 22 of container 10. Closed end 24, sidewall 26, and closure assembly 40 define a cavity in which the electrodes of the cell are housed. As will be described in greater detail later in this disclosure, the first electrode 18 and second electrode 12 may be stacked vertically with multiple separators 14 embodied collectively as a set of separators disposed between them. In some embodiments, multiple first electrodes 18 and second electrodes 12 may be stacked vertically in an alternating arrangement with individual separators 14 from the set of separators 14 disposed between them. For example, a stack may include a second electrode on the bottom of the stack, a separator, a first electrode, another separator, and then another second electrode, with the stack continuing in this arrangement until the electrochemical cell is filled or a desired height is reached for the stack. It should be understood that in other embodiments, a first electrode is positioned on the bottom of the stack. This stacked configuration and variations will be described in greater detail later in this disclosure.

Closure assembly 40 comprises a closure member 42 such as a gasket, a current collector 44 and conductive terminal 46 in electrical contact with current collector 44. Closure member 42 preferably contains a pressure relief vent that will allow the closure member to rupture if the cell's internal pressure becomes excessive. Closure member 42 can be formed from a polymeric or elastomeric material, for example Nylon-6,6, an injection-moldable polymeric blend, such as polypropylene matrix combined with poly(phenylene oxide) or polystyrene, or another material, such as a metal, provided that the current collector 44 and conductive terminal 46 are electrically insulated from container 10 which serves as the current collector for the second electrode 12 (cathode). In the embodiment illustrated, current collector 44 is an elongated nail or bobbin-shaped component extending into the first electrode 18 (anode). Current collector 44 is made of one or more metals or metal alloys, such as copper or brass. In certain embodiments, portions of the current collector 44 may be a conductively plated nail/rod having a metallic or plastic core that is plated with the one or more metals or metal alloys. Other suitable materials can be utilized. Current collector 44 is inserted through a hole (e.g., a centrally located hole) in closure member 42. In some embodiments, the electrodes 12 and 18 may be configured to be annular in shape, and the current collector 44 may be disposed through the center of the annulus.

First electrode 18 is preferably a negative electrode or anode. The negative electrode includes a mixture of one or more active materials, an electrically conductive material, optionally solid zinc oxide, and a surfactant. The negative electrode can optionally include other additives, for example a binder or a gelling agent, and the like. Example anode compositions usable within the electrochemical cells discussed herein are described in detail in U.S. Patent Publ. No. 2023/0107037, which is incorporated herein by reference in its entirety.

Zinc is an example main active material for the negative electrode of the embodiments. Mercury, aluminum, silicon, lithium, and magnesium may also be used, in alternate embodiments. Preferably, the volume of active material utilized in the negative electrode is sufficient to maintain a desired particle-to-particle contact and a desired anode to cathode (A:C) ratio.

Particle-to-particle contact should be maintained during the useful life of the battery. If the volume of active material in the negative electrode is too low, the cell's voltage may suddenly drop to an unacceptably low value when the cell is powering a device. The voltage drop is believed to be caused by a loss of continuity in the conductive matrix of the negative electrode. The conductive matrix can be formed from undischarged active material particles, conductive electrochemically formed oxides, or a combination thereof. A voltage drop can occur after oxide has started to form, but before a sufficient network is built to bridge between all active material particles present.

Zinc suitable for use in the embodiments may be procured from a number of different commercial sources under various designations, such as BIA 100, BIA 115. Umicore S. A., Brussels, Belgium is an example of a zinc supplier. In a preferred embodiment, the zinc powder generally has 25 to 40 percent fines less than 75 μm, and preferably 28 to 38 percent fines less than 75 μm. Generally lower percentages of fines will not allow desired DSC service to be realized and utilizing a higher percentage of fines can lead to increased gassing. A correct zinc alloy is needed in order to reduce negative electrode gassing in cells and to maintain test service results.

A surfactant that is either a nonionic or anionic surfactant, or a combination thereof is usually present in the negative electrode. It has been found that anode resistance is increased during discharge by the addition of solid zinc oxide alone, but is mitigated by the addition of the surfactant. The addition of the surfactant increases the surface charge density of the solid zinc oxide and lowers anode resistance as indicated above.

One example surfactant is DISPERBYK-190 from BYK-Chemie GmbH of Wesel, Germany. The surfactant is present in an amount sufficient to disperse the solid zinc oxide, preferably about 0.00064 to about 0.20 weight percent or more, based on the total weight of the negative electrode. DISPERBYK-190 is believed to be a solution including a water soluble, high molecular weight block copolymer including one or more functional groups, believably at least two different types of functional groups. The surfactant has an anionic/nonionic character due to the respective functional groups thereof. It is further believed that the number average molecular weight of a block copolymer DISPERBYK-190 is greater than 1000 measured utilizing gel permeation chromatography. Water solubility may be offset by the presence of a hydrophobic component if present in the electrode composition. In one embodiment, the surfactant is utilized in an amount from about 10 to about 100 ppm and preferably from about 15 to about 50 ppm of zinc utilized in the negative electrode. It is believed that DISPERBYK-190 does not contain any organic solvents and is, therefore, suitable for aqueous systems. DISPERBYK-190 has an acid value in mg KOH/g of 10 and a density of 1.06 g/ml at 20 °C.

In an embodiment, the negative electrode comprises solid zinc oxide in an amount from about 0.2 to 5 weight percent, based on the total weight of the negative electrode. In an embodiment, the negative electrode comprises solid zinc oxide in an amount from about 1 to 4 weight percent. In a preferred embodiment, the negative electrode comprises solid zinc oxide in an amount from about 0.3 to 1 weight percent. In a more preferred embodiment, the negative electrode comprises solid zinc oxide in an amount of about 0.66 weight percent.

In an embodiment, the solid zinc oxide is substituted so as to reduce its solubility. In an embodiment, a portion of the zinc in the solid zinc oxide is substituted with another cation. In an embodiment, the substituted solid zinc oxide has the formula Zn₁₋ₓYₓO, wherein Y is at least one cation substituent, and 0<x≤0.50. In an embodiment, the cation substituent is selected from the group consisting of Mg, Ca, Bi, Ba, Al, Si, Be, Cd, Ni, Co, Sn, and Sr, and any combination thereof. In an embodiment, x is 0.01-0.40, or 0.02-0.35, or 0.4-0.30, or 0.05-0.25, or 0.10-0.20. In an embodiment, x is ≥0.01, ≥0.02, ≥0.04, ≥0.06, ≥0.08, ≥0.10, ≥0.12, ≥0.14, ≥0.16, ≥0.18, ≥0.20, ≥0.25, ≥0.30, ≥0.35, or ≥0.40.

In an embodiment, a portion of the oxygen in the solid zinc oxide is substituted with another anion. In an embodiment, the substituted solid zinc oxide has the formula ZnO_{1-w}A_{(2w/z)}, wherein A is at least one anion substituent, 0<w≤0.50, and z is the charge of the anion substituent. In an embodiment, the anion substituent is selected from the group consisting of CO₃²⁻ and PO₄³⁻, and a combination thereof. In an embodiment, w is 0.01-0.40, or 0.02-0.35, or 0.4-0.30, or 0.05-0.25, or 0.10-0.20. In an embodiment, w is ≥0.01, ≥0.02, ≥0.04, ≥0.06, ≥0.08, ≥0.10, ≥0.12, ≥0.14, ≥0.16, ≥0.18, ≥0.20, ≥0.25, ≥0.30≥0.35, or ≥0.40. In an embodiment, the solid zinc oxide comprises a cation substituent and an anion substituent.

In an embodiment, the aqueous electrolyte is an aqueous, alkaline metal hydroxide electrolyte, and comprises an alkaline metal hydroxide such as potassium hydroxide (KOH), sodium hydroxide (NaOH), or the like, or mixtures thereof. Potassium hydroxide is preferred. The alkaline electrolyte used to form the gelled electrolyte of the negative electrode contains the alkaline metal hydroxide in an amount from about 26 to about 36 weight percent, for example from about 26 to about 32 weight percent, and specifically from about 26 to about 30 weight percent based on the total weight of the alkaline electrolyte. Interaction takes place between the negative electrode alkaline metal hydroxide and the added solid zinc oxide, and it has been found that lower alkaline metal hydroxide improves DSC service. Electrolytes which are less alkaline are preferred, but can lead to rapid electrolyte separation of the anode. Increase of alkaline metal hydroxide concentration creates a more stable anode, but can reduce DSC service. The metal ions in the electrolyte can have a concentration of 0.1-20,000 ppm. In alternate embodiments, the electrolyte may be neutral or salt-based, as in a zinc-carbon cell.

The aqueous alkaline electrolyte solution also comprises dissolved zinc oxide in an amount from about 1.5 to 4 weight percent, based on the total weight of the aqueous alkaline electrolyte solution.

A gelling agent is preferably utilized in the negative electrode as is well known in the art, such as a crosslinked polyacrylic acid, such as Carbopol® 940, which is available from Noveon, Inc. of Cleveland, Ohio, USA. Carboxymethylcellulose, polyacrylamide and sodium polyacrylate are examples of other gelling agents that are suitable for use in an alkaline electrolyte solution. Gelling agents are desirable in order to maintain a substantially uniform dispersion of zinc and solid zinc oxide particles in the negative electrode. The amount of gelling agent present is chosen so that lower rates of electrolyte separation are obtained and anode viscosity in yield stress are not too great which can lead to problems with anode dispensing.

Dissolved zinc oxide is present in the anode, preferably via dissolution in the aqueous electrolyte solution, in order to improve plating on the nail current collector and to lower negative electrode off gassing. The dissolved zinc oxide added is separate and distinct from the solid zinc oxide present in the anode composition. Levels of dissolved zinc oxide in an amount of 3-4 weight percent based on the total weight of the negative electrode electrolyte solution are preferred in one embodiment. In an embodiment, the dissolved zinc oxide is present in the negative electrode electrolyte solution in an amount of greater than 3 weight percent. The soluble or dissolved zinc oxide generally has a BET surface area of about 4 m²/g or less measured utilizing a Tristar 3000 BET specific surface area analyzer from Micrometrics having a multi-point calibration after the zinc oxide has been degassed for one hour at 150 °C.; and a particle size D50 (mean diameter) of about 1 micron, measured using a CILAS particle size analyzer as indicated above.

Other components which may be optionally present within the negative electrode include, but are not limited to, gassing inhibitors, organic or inorganic anticorrosive agents, plating agents, binders or other surfactants. Examples of gassing inhibitors or anticorrosive agents can include indium salts, such as indium hydroxide, perfluoroalkyl ammonium salts, alkali metal sulfides, etc.

The negative electrode can be formed in a number of different ways as known in the art. For example, the negative electrode components can be dry blended and added to the cell, with alkaline electrolyte being added separately or, as in a preferred embodiment, a pre-gelled negative electrode process is utilized.

In one embodiment, the zinc and solid zinc oxide powders, and other optional powders other than the gelling agent, are combined and mixed. Afterwards, the surfactant is introduced into the mixture containing the zinc and solid zinc oxide. A pre-gel comprising alkaline electrolyte, soluble zinc oxide and gelling agent, and optionally other liquid components, are introduced to the surfactant, zinc and solid zinc oxide mixture which are further mixed to obtain a substantially homogenous mixture before addition to the cell. Alternatively, in a further preferred embodiment, the solid zinc oxide is predispersed in a negative electrode pre-gel comprising the alkaline electrolyte, gelling agent, soluble zinc oxide and other desired liquids, and blended, such as for about 15 minutes. The solid zinc oxide and surfactant are then added and the negative electrode is blended for an additional period of time, such as about 20 minutes. The amount of gelled electrolyte utilized in the negative electrode is generally from about 25 to about 35 weight percent, and for example, about 32 weight percent based on the total weight of the negative electrode. Volume percent of the gelled electrolyte may be about 70% based on the total volume of the negative electrode.

In addition to the aqueous alkaline electrolyte absorbed by the gelling agent during the negative electrode manufacturing process, an additional quantity of an aqueous solution of alkaline metal hydroxide, i.e., “electrolyte shot,” “free electrolyte,” or “alkaline electrolyte solution,” is added to the cell during the manufacturing process. The electrolyte shot may be incorporated into the cell by disposing it into the cavity defined by the positive electrode or negative electrode, or combinations thereof. The method used to incorporate the electrolyte shot into the cell is not critical provided it is in contact with the negative electrode, positive electrode, and separator. In one embodiment, an electrolyte shot is added both prior to addition of the negative electrode mixture as well as after addition. In one embodiment, about 0.97 grams of 29 weight percent KOH solution is added to an LR6 type cell as an electrolyte shot, with about 0.87 grams added to the separator lined cavity before the negative electrode is inserted. The remaining portion of the 29 weight percent KOH solution is injected into the separator lined cavity after the negative electrode has been inserted. In certain embodiments, an electrolyte shot comprises an alkaline metal hydroxide electrolyte (e.g., KOH). The alkaline metal hydroxide electrolyte may have dissolved zinc oxide or zinc hydroxide. In certain embodiments, the alkaline metal hydroxide electrolyte comprises dissolved zinc oxide in a range of about 0.01-6.0 weight percent. In embodiments, the electrolyte shot comprises dissolved zinc oxide equivalent in an amount of greater than 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, or 14.0 weight percent.

This electrolyte shot, in an embodiment, comprises the metal additive and is the source of metal ions which will adsorb to the manganese dioxide-containing cathode. In an embodiment, the same metal additive present in the electrolyte shot is present in the electrolyte solution incorporated into the cathode. In an embodiment, the electrolyte shot has a different concentration of metal additive than does the cathode electrolyte solution. In an alternate embodiment, the electrolyte shot and the cathode electrolyte solution have the same concentration of the metal additive. In an embodiment, the metal additive present in the electrolyte shot is not present in the cathode.

In an embodiment, the metal additive will be insoluble or have very low solubility in the electrolyte solution at room temperature (~25 °C). In an embodiment, the metal additive will have a solubility of less than 1×10^{-x}, where x is from 10-75.

Second electrode 12, also referred to herein as the positive electrode or cathode, preferably includes manganese dioxide (typically as EMD) as the electrochemically active material. EMD is present in an amount generally from about 80 to about 92 weight percent and preferably from about 81 to 85 weight percent based on the total weight of the positive electrode, i.e., manganese dioxide, conductive material, positive electrode electrolyte and additives, including organic additive(s), if present. The positive electrode is formed by combining and mixing desired components of the electrode followed by dispensing a quantity of the mixture into the open end of the container and then using a ram to mold the mixture into a solid tubular configuration that defines a cavity within the container in which the separator 14 and first electrode 18 are later disposed. Second electrode 12 has a ledge 30 and an interior surface 32 as illustrated in FIG. 1. Alternatively, the positive electrode may be formed by pre-forming a plurality of rings from the mixture comprising EMD, and optionally additive(s), and then inserting the rings into the container to form the tubular-shaped second electrode. The cell shown in FIG. 1 would typically include 3 or 4 rings.

The positive electrode can include other components such as a conductive material, for example graphite, that when mixed with the EMD provides an electrically conductive matrix substantially throughout the positive electrode. Conductive material can be natural, i.e., mined, or synthetic, i.e., manufactured. In one embodiment, the cells include a positive electrode having an active material or oxide to carbon ratio (O:C ratio) that ranges from about 12 to about 24. In an embodiment, the O:C ratio ranges from about 12-14. Too high of an oxide to carbon ratio decreases the container to cathode resistance, which affects the overall cell resistance and can have a potential effect on high rate tests, such as the DSC test, or higher cut-off voltages. Furthermore, the graphite can be expanded or non-expanded. Suppliers of graphite for use in alkaline batteries include Timcal America of Westlake, Ohio; Superior Graphite Company of Chicago, Ill.; and Lonza, Ltd. of Basel, Switzerland. Conductive material is present generally in an amount from about 5 to about 10 weight percent based on the total weight of the positive electrode. Too much graphite can reduce EMD input, and thus cell capacity; too little graphite can increase container to cathode contact resistance and/or bulk cathode resistance. An example of an additional additive is barium sulfate (BaSO₄), which is commercially available from Bario E. Derivati S.p.A. of Massa, Italy. The barium sulfate is present in an amount generally from about 1 to about 2 weight percent based on the total weight of the positive electrode. Other additives can include, for example, barium acetate, titanium dioxide, binders such as coathylene, and calcium stearate.

In an embodiment, the cathode comprises the metal additive as a solid. In an embodiment, the metal additive is present as a solid in the cathode at a concentration of 0.1-1000 ppm compared to the total mass of the cathode.

In some embodiments, the cathode may include nickelate materials as described in U.S. Pat. No. 11,560,321, which is incorporated herein by reference in its entirety.

In one embodiment, a positive electrode component (EMD), conductive material, and barium sulfate, and optionally additive(s) are mixed together to form a homogeneous mixture. During the mixing process, an alkaline electrolyte solution, such as from about 37% to about 40% KOH solution, optionally including organic additive(s), is evenly dispersed into the mixture thereby insuring a uniform distribution of the solution throughout the positive electrode materials. The mixture is then added to the container and molded utilizing a ram. Moisture within the container and positive electrode mix before and after molding, and components of the mix are preferably optimized to allow quality positive electrodes to be molded. Mix moisture optimization allows positive electrodes to be molded with minimal splash and flash due to wet mixes, and with minimal spalling and excessive tool wear due to dry mixes, with optimization helping to achieve a desired high cathode weight. Moisture content in the positive electrode mixture can affect the overall cell electrolyte balance and has an impact on high rate testing.

One of the parameters utilized by cell designers characterizes cell design as the ratio of one electrode's electrochemical capacity to the opposing electrode's electrochemical capacity, such as the anode (A) to cathode (C) ratio, i.e., A:C ratio. For an LR6 type alkaline primary cell that utilizes zinc in the negative electrode or anode and MnO₂ in the positive electrode or cathode, the A:C ratio may be greater than 1.32:1, such as greater than 1.34:1, and specifically 1.36:1 for impact molded positive electrodes. The A: C ratio for ring molded positive electrodes can be lower, such as about 1.3:1 to about 1.1:1. The cathode may be ring molded, in some embodiments.

Separator 14 is provided in order to separate first electrode 18 from second electrode 12. Separator 14 maintains a physical dielectric separation of the positive electrode's electrochemically active material from the electrochemically active material of the negative electrode and allows for transport of ions between the electrode materials. In addition, the separator acts as a wicking medium for the electrolyte and as a collar that prevents fragmented portions of the negative electrode from contacting the top of the positive electrode. Separator 14 can be a layered ion permeable, non-woven fibrous fabric. A typical separator usually includes two or more layers of paper. Conventional separators are usually formed either by pre-forming the separator material into a cup-shaped basket that is subsequently inserted under the cavity defined by second electrode 12 and closed end 24 and any positive electrode material thereon, or forming a basket during cell assembly by inserting two rectangular sheets of separator into the cavity with the material angularly rotated 90° relative to each other. Conventional pre-formed separators are typically made up of a sheet of non-woven fabric rolled into a cylindrical shape that conforms to the inside walls of the second electrode and has a closed bottom end.

### Example Alkaline Electrochemical Cells With Stacked Electrodes

Batteries with high anode/cathode interfacial areas may have a better high-rate performance (e.g., a longer run-time for high-discharge devices). However, electrochemical cells having a high interfacial area require a corresponding high separator surface area to keep the anode and cathode electrically separated. Due to the increased volume attributable to higher surface area of included separator material, electrochemical cells having increased interfacial area between electrodes (as compared with traditional bobbin-style cells as described and illustrated with respect to FIG. 1) have limited remaining volume for the active materials of the anode and cathode. In addition, high interfacial area cell designs that have multiple anodes and/or multiple cathodes require additional current collectors for each electrode to electrically connect the electrodes to their respective terminals on the exterior of the cell. Again, these required current collectors occupy additional volume within the cell, further limiting the amount of space available for active materials. Moreover, these configurations increase the complexity of the production assembly for the electrochemical cell.

In contrast to the conventional “bobbin” style design of electrochemical cells, the example stacked-electrode cell configurations described herein includes tablet-shaped electrodes (e.g., cylindrical, square, rectangular, and/or other shapes). The tablet-shaped electrodes have a perimeter shaped to fit within a cell can (e.g., a circular perimeter to fit within a cylindrical cell). The tablet-shaped electrodes have dual interfaces between adjacent electrodes; that is, each tablet-shaped electrode may be separated (with a separator) from another electrode on top or bottom of the electrode. As specific examples, anode electrodes may be positioned with cathode electrodes disposed on either side of the anode electrodes (both above and below the anode electrode) and cathode electrodes with anode electrodes disposed on either side of the cathode electrodes (both above and below the cathode electrodes). Multiple tablet-shaped electrodes may be positioned within the cell to fill the cell canister. As an example, two electrodes (e.g., one anode and one cathode), 3 electrodes (e.g., two cathodes and one anode), 4 electrodes, 5 electrodes, 6 electrodes, 7 electrodes, and/or the like may be disposed within the cell canister. The height of the tablet-shaped electrodes may be determined by the total number of electrodes to be positioned within the cell canister to maximize the amount of active material within the electrodes that are placed within the cell. For example, the tablet-shaped electrodes of a cell having 5 tablet-shaped electrodes positioned therein are taller than the tablet-shaped electrodes of a cell having 7 tablet-shaped electrodes positioned therein (for the same size and shape cell). As discussed in greater detail herein, each of the tablet-shaped electrodes comprise insulating components to insulate the electrode active material from current collectors of the opposite polarity. For example, cathode electrode-tablets comprise centrally-located insulating components (e.g., a centrally located insulating sleeve and/or grommets lining a centrally-located hole extending through the cathode) to insulate the cathode active material from a centrally located anode current collector (e.g., a current collector nail extending along a central axis of the cell). Anode electrode-tablets comprise ring-shaped insulating components positioned on an outer perimeter of the anode electrode tablet (e.g., a ring-shaped gasket positioned around an exterior perimeter of the anode electrode tablet and/or one or more lids/caps secured to the ring-shaped gasket) to insulate the anode active material from the cell can, which acts as the cathode current collector. Separator disks are further provided to separate the anode and cathode active material from one another.

While these tablet-shaped electrodes require additional non-active materials within the cell (e.g., additional separator material, insulating components not present in bobbin-style cells, and/or the like), the increased surface area between electrodes contributes to a more complete discharge of active material within the electrodes during high-rate discharge as compared with bobbin-style cells, and accordingly the theoretical capacity of cells having stacked electrode tablets is higher than bobbin-style cells having the same electrode active-material composition.

These configurations may also be distinguished from other example cell configurations, such as “jelly roll” style cells, which may require a metal foil current collector to block diffusion. The configurations described in this disclosure may also include electrodes having reduced thicknesses compared to those in the “bobbin” and “jelly roll” styles of cell.

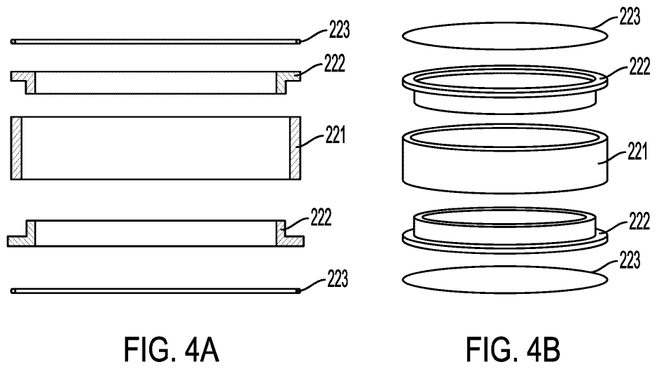

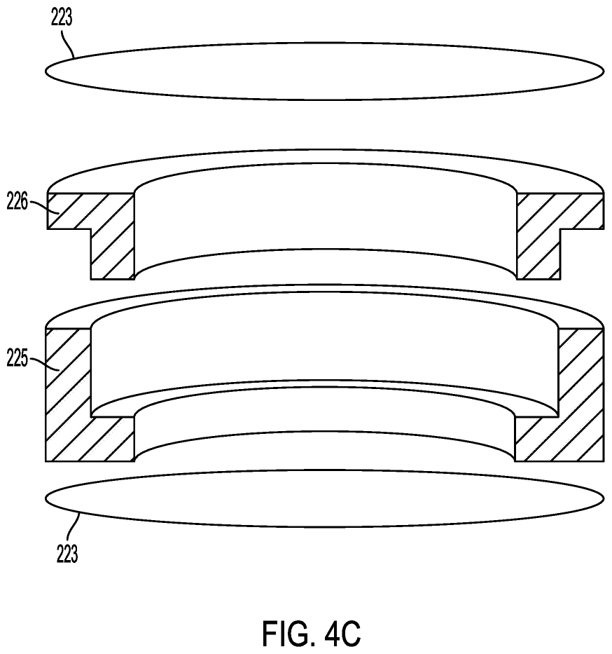

FIGS. 2A-4C illustrate an electrode configuration (tablet-shaped electrodes positioned within a stack of electrodes comprising two or more electrodes) for an electrochemical cell having an increased interfacial area (per volumetric quantity of active material) between the anode and cathode compared with the bobbin-style cell illustrated in FIG. 1. Specifically, FIG. 2A is a schematic diagram of a cut-away view of an electrochemical cell, cut along a vertical, central plane of the electrochemical cell. FIG. 2B is an x-ray view of an example electrochemical cell having the configuration discussed herein. FIGS. 3A-4C illustrate schematic and exploded views of anode and cathode components (alternatively referred to herein as electrode “tablets”) that can be positioned within an electrochemical cell with a stacked electrode configuration. In the stacked electrode configuration shown in the figures, each electrode is embodied as an annular “tablet” within the stack. As discussed previously, other electrode tablet shapes may be provided in certain embodiments to accommodate other electrochemical cell shapes. These tablet-shaped electrodes are stacked within the electrochemical cell can in an alternating arrangement (e.g., alternating between anode and cathode tablets along the height of the stack of electrodes within the electrochemical cell). Adjacent electrodes are separated from one another by one or more layers of separator material (e.g., separator paper provided as separator disks that may be secured as a part of one or more of the electrodes). In certain embodiments, the number of anode electrodes is the same as the number of cathode electrodes, although in other embodiments the number of anode electrodes may differ from the number of cathode electrodes.

It will be understood that the figures shown and described in this disclosure are illustrative and some components (including but not limited to the separators, the can, and the current collector) have been removed for clarity and to highlight various components of the disclosed embodiments. Moreover, the active material composition of each of the anode, the cathode, the current collector, the separator sheets, the can, and other components as described in reference to FIG. 1 may be utilized with the embodiment of FIGS. 2A-4C. For example, when referring to various electrodes in the description for FIGS. 2A-4C, the description of the first electrode 18 (e.g., an anode) and the second electrode 12 (e.g., a cathode)—including the compositions thereof—from the previous sections of this disclosure may apply to the first and second electrodes shown and described for FIGS. 2A-4C.

Referring now to FIGS. 2A-4C, in some embodiments, an electrochemical cell 200 is provided. FIGS. 2A-2B illustrate views of an assembled cell 200 with a stack of tablet-shaped electrodes therein, while FIGS. 3A-3B illustrate single cathode tablet for placement in the stack of the cell 200 in exploded view to show the various components of the cathode tablet, according to various embodiments. FIGS. 4A-4C illustrate exploded views of example anode tablets for placement in the stack of electrodes in cell 200 according to certain embodiments.

In some embodiments, the cell 200 includes a plurality of first electrodes 207 (anodes) and a plurality of second electrodes 205 (cathodes) arranged in a stack within the cell 200. In some embodiments, the plurality of first electrodes 207 may be collectively considered a set of first electrodes and the plurality of second electrodes 205 may be collectively considered a set of second electrodes. This stack arrangement can be seen in at least FIGS. 2A-2B, with the stack alternating between first electrodes 207 and second electrodes 205. Also as shown in FIGS. 2A-2B, a second electrode 205 (cathode) is disposed on the bottom of the stack, while a first electrode 207 (anode) is disposed on top of the stack. In some embodiments, the first and second electrodes 207, 205 may be disposed within a can 210 that acts as a current collector and is in conductive contact with each of the second electrodes 205 (via exposed sidewall of the second electrodes 205). Accordingly, the second electrodes 205 may be in contact with the interior walls of the can, while the first electrodes 207 may be insulated from the interior walls of the can 210 (e.g., by an anode gasket 201, as will be described later). In some embodiments, the first and second electrodes 207, 205 may have an annular shape within a cylindrical cell 200. In some embodiments, a current collector 209 may be disposed within the cell 200 and in conductive contact with each first electrode 207. In some embodiments, the current collector 209 may be disposed within a central opening extending centrally through each second electrode 205 (while being electrically insulated from the cathode material by grommets, discussed herein) and the anodes. In some embodiments, the current collector 209 may be configured such that it does not extend into (or entirely through) the second electrode 205 on the bottom of the stack.

In some embodiments, the first electrode 207 may have the composition of anode 18 as described previously with respect to FIG. 1. In some embodiments, the first electrode 207 may include zinc active material disposed in an electrolyte shot. In some embodiments, the first electrode 207 may be contained within an anode gasket 201 to electrically insulate the first electrode 207 from the can 210. In some embodiments, the anode gasket 201 may be ring-shaped and have an interference fit against the can 210 for a secure fit. In some embodiments, the anode gasket 201 may be composed of a thermoplastic material, such as polypropylene or nylon. Moreover, the anode gasket 201 may press against the separator (discussed below) to impede leakage of electrode material around edges of the separator, which may create a short circuit between adjacent anodes and cathodes.

FIGS. 4A-4C illustrate alternative embodiments of anode gaskets 201 according to certain embodiments. In the embodiment of FIGS. 4A-4B, which includes both a cutaway view (FIG. 4A) and exploded view (FIG. 4B), the anode gasket 201 comprises a sleeve 221 (e.g., a cylindrical sleeve) surrounding the perimeter of the anode material (not shown). Grommets 222 are secured on either end of the sleeve 221, with interior portions of the grommets extending into the interior of the sleeve. The grommets 222 may be constructed of the same material as the sleeve 221. The grommets 222 may be friction fit into the interior of the sleeve, such that an outer surface of the interior portion of each grommet 222 is in frictional contact with an interior surface of the sleeve 221. As shown, the grommets 222 additionally comprise an exterior portion having a diameter that at least substantially matches the exterior diameter of the sleeve 221. The grommets 222 are additionally characterized by an at least substantially planar end surface, against which a separator disk 223 (comprising the material of a separator as discussed herein) is secured (e.g., adhered using an adhesive). The resulting anode tablet 207 is sealed within the sleeve 221, grommets 222, and separator disks 223. As discussed herein, the separator disks 223 can be pierced by a nail current collector 209 during assembly of the electrochemical cell 200 to electrically connect the anode material within the anode tablets 207 with a negative terminal of the electrochemical cell 200.

FIG. 4C illustrates a cutaway view of another alternative embodiment of anode gasket 201 according to certain embodiments. As shown in FIG. 4C, the anode gasket 201 comprises an anode cup 225 (e.g., a cylindrical anode cup), an anode lid 226 (e.g., a cylindrical anode lid) secured (e.g., frictionally secured, adhered, and/or the like) with the anode cup 225 to form the anode gasket 201, and separator disks 223 secured onto opposite open ends of the anode gasket 201. In the illustrated embodiment, the anode cup 225 defines a cylindrical outer surface having a hollow interior. The hollow interior is defined by a stepped interior surface having a wide portion and a narrow portion. The narrow portion has an interior surface that is parallel with an interior surface of the wide portion. The narrow portion defines a first open end of the anode gasket 201, against which a separator disk 223 is secured (e.g., adhered).

The anode lid 226 may be formed from the same material as the anode cup 225 (e.g., an insulating material). Although not drawn to scale in FIG. 4C, the anode lid 226 of the illustrated embodiment defines an at least substantially uniform cylindrical interior surface. The diameter of the interior surface is at least substantially identical to the diameter of the interior surface of the narrow portion of the anode cup 225. The exterior surface of the anode lid 226 defines a stepped profile that securely fits within the wide portion of the anode cup 225. The anode lid 226 has a length to fit within the anode cup 225 such that the at least substantially uniform cylindrical interior surface of the anode lid is positioned adjacent the narrow portion of the anode cup 225 to collectively define an at least substantially continuous interior surface of the anode gasket 201 that surrounds the anode material. As shown, a separator disk 223 is secured (e.g., adhered) onto an open end of the anode lid 226 to seal the anode material within the anode gasket 201.

In some embodiments, the second electrode 205 may have the composition of cathode 12 as previously described with respect to FIG. 1. In some embodiments, and as shown in the exploded views in FIGS. 3A-3B, the second electrode 205 may be an assembly including a tablet 208 with one or more ion-permeable separator sheets 203, 204 (including a first ion-permeable separator sheet and a second ion-permeable separator sheet having a different composition than the first separator) disposed on either side (top and bottom) of the tablet 208 and a centrally-located grommet (embodied as a two-part grommet including a male grommet and a female grommet 202, 206) separating the second electrode 205 from the current collector 209. As shown, the second electrode 205 has an exposed sidewall (extending between the separator sheets on top and bottom of the second electrode 205) such that the active material within the cathode is placed in electrical contact with the cell canister that acts as a cathode current collector when the tablet-shaped second electrode 205 is placed within the cell canister.

In some embodiments, the tablet 208 may be a cathode tablet 208. In some embodiments, the one or more separator sheets 203, 204 may be part of a set of separators including multiple separator sheets 203, 204. In certain embodiments separator sheet 203 is a first separator and separator sheet 204 is a second separator. The first separator sheet 203 and the second separator sheet 204 may comprise the same separator material (being of the same separator composition) or may comprise different separator materials (being of different separator compositions). Like the anode gasket 201, the opposite sides of the grommet may press onto the separators to further seal against short circuits created around the separator layers between adjacent electrodes. In some embodiments, the grommet 202, 206 may be separator material, and the second electrode 205 may be sealed within the separator sheets 203, 204, which would render the grommet 202, 206 unnecessary.

In some embodiments, the grommets 202, 206 may be electrically insulating between the first electrode 207 and second electrode 205. In some embodiments, the grommets 202, 206 may aid in guiding the insertion of the current collector 209; that is, the current collector 209 may be disposed through the internal hole of the grommets 202, 206. In some embodiments, the grommets 202, 206 may be friction fit with the exterior surface of the current collector 209; in other embodiments, the current collector 209 may be disposed through the internal hole of the grommets 202, 206 such that space is left between the interior surface of the grommets 202, 206 and the exterior surface of the current collector 209.

As shown in FIG. 3B, a cylindrical sleeve 232 may be positioned within a central aperture of tablet 208, and grommets 231 may be secured within an interior of the central sleeve 232 (e.g., via an adhesive or friction fit). The grommets 232 may have enlarged diameter end portions that extend radially outward, beyond an exterior cylindrical surface of the sleeve 232. Those enlarged diameter end portions may be configured to cover at least a portion of a separator sheet 203 (a disk-shaped separator sheet 203) positioned on opposite ends of the tablet 208 to secure the separator sheet 203 onto the tablet 208. As shown, the tablet 208 has an exposed exterior cylindrical surface that is placed in electrical contact with the interior surface of the electrochemical cell can when the tablet 208 is placed into the electrochemical cell.

In some embodiments, the separator sheets 203, 204 may be disposed on only one side of the tablet 205. For example, regarding the second electrode 205 on the bottom of the stack of electrodes within the cell 200, the tablet 208 for that bottom second electrode 205 may have separator sheets 203, 204 disposed only on the “top” side (the side that interfaces with the first electrode 207) of the cathode tablet 208. In such a configuration, the bottom side of the second electrode 205 may be in electrical contact with the cell can 210, which acts as a current collector.

In some embodiments, the male and female grommets 202, 206 may be interlocked, and the interlocking length may be varied to allow for a range of thicknesses in the electrodes 205, 207. In some embodiments, the tablet 208 may include cathode material, as previously described in this disclosure.

In some embodiments, the separator sheets 203, 204 may be paper disks that act as electrical insulators and are ionically conductive. The separator sheets 203, 204 may be annular with center holes. In some embodiments, the separator sheet 203 that is adjacent to the first electrode 207 may be of a different material than the other separator sheet 204. In some embodiments, the separator sheets 203, 204 may be composed of a variety of materials, including non-woven papers with compositions of cellulose and PVA fibers, bilayer paper with a higher density side, and/or cellophane.

In some embodiments, one or more of the separator sheets 203, 204 may be disposed within the anode gasket 201 and prevents the anode active material from seeping between various components of the cell 200 to create a short-circuit (e.g., upon contacting the cathode active material or the cathode current collector).

In some embodiments, a sealant (e.g., an adhesive) may be used to improve anode containment between the separator sheets 203, 204 and the anode gasket 201.

In some embodiments, the cell 200 may include a collector gasket 212 that may be a gasket as described at least with reference to FIG. 1 and the associated description, as previously disclosed. In some embodiments, the gasket 212 may be a plastic gasket with a safety venting feature. In some embodiments, the collector gasket 212 and the anode gasket 201 are tightly fitted to contain the first electrode 207 on top of the stack of electrodes. In some embodiments, the cell 200 may also include an electrolyte shot that is dispensed into the cell 200 and into the center of the annulus-shaped electrode tablets 207, 205 to saturate each separator sheet 203, 204 and to fill out the excess irregular space below the collector gasket 212.

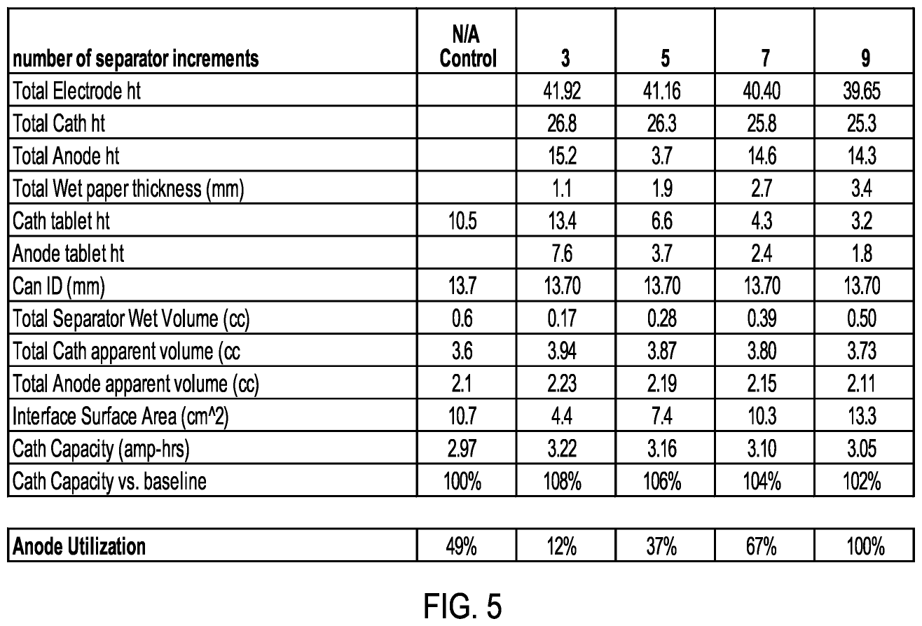

FIG. 5 is a table showing components of different example configurations of stacked electrode embodiments of an LR6 electrochemical cell. These are merely examples, and other sizes of tablets, numbers of tablets, and/or the like may be utilized in certain embodiments. In some embodiments, and as shown in FIG. 2A, the stack may have a second electrode 205 on the bottom of the stack and a first electrode 207 on the top of the stack. In some embodiments, there may be four second electrodes and four first electrodes disposed in the cell 200, for a total of eight electrodes and seven separator interfaces between adjacent first electrodes 207 and second electrodes 205. The number of electrodes in a stack within the cell 200 may increase to improve rate capability of the cell 200, but this may have trade-offs that affect performance in other areas. For example, increasing the number of electrodes within a cell requires a reduction in the height of each tablet. Changes in the height of electrodes may have a corresponding change in the height of the grommet and gasket, as described herein. While an increase in the number of electrode tablets has a corresponding increase in the interfacial area between anodes and cathodes within the cell, increasing the number of electrode tablets requires an increase in the amount of separator material within the cell, which consequently reduces the cell volume that may be usable for active materials. This may result in an increase in high-rate performance, but a decrease in low-rate performance (due to the reduction in active material in the cell).

Still referring to FIG. 5, the second column shows a control cell (e.g., a cell with a bobbin-style configuration as in FIG. 1). The remaining columns provide detail of example cells with three, five, seven, and nine separator increments separating first and second electrode tablets 207, 205, where the first electrode 207 comprises anode active material and the second electrode 205 comprises cathode active material. The column on the left shows various properties of electrochemical cells and their components (e.g., total electrode height, total wet paper thickness, interface surface area, etc.), and their associated rows show how those properties vary depending on the configuration of the electrodes and separators within the cells. The bottom row shows the anode utilization percentage during discharge for each configuration. It should be noted that the values for anode utilization are estimated based on a function of the number of electrodes in the stack. However, at least as shown in FIG. 5, increasing the number of separator increments (and thereby increasing the interface surface area) is calculated to increase anode utilization up to 100% for nine separator increments. Increasing the number of separator increments is also calculated to decrease the cathode capacity as compared with the baseline cell.

The table shown in FIG. 5 also describes other predicted properties of various electrochemical cells with stacked tablet configurations. For example, increasing the number of separator tablets leads to a corresponding decrease in the height of the electrodes 205, 207 so that the electrodes 205, 207 fit within the cell 200. In some embodiments, the electrodes may have identical heights, while in other embodiments, the electrodes may have different heights within a single cell 200. In some embodiments, the electrodes may all have center holes (e.g., to accommodate a current collector). Such a configuration eases manufacturing. In other embodiments, the bottom-most electrode (e.g., a cathode tablet) may not have a center hole therein. As another example, the total separator wet volume may increase as the total number of separator increments increases.

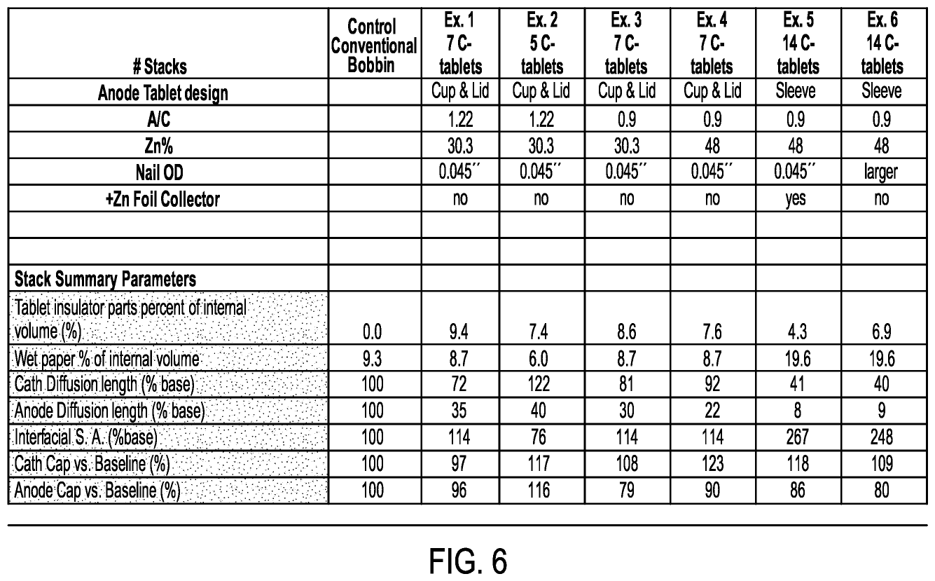

FIG. 6 shows another table summarizing characteristics of certain electrochemical cells comprising electrode tables as discussed herein. Six example cell designs (Ex. 1-6) are summarized and compared against a conventional bobbin cell design that is summarized as a control. In FIG. 6, Ex. 1 describes a cell design using 7 cathode tablets; Ex. 2 describes a cell design using 5 cathode tablets; Ex. 3 describes a cell design using 7 cathode tablets; Ex. 4 describes a cell design using 7 cathode tablets; Ex. 5 describes a cell design using 14 cathode tablets; and Ex. 6 describes a cell design using 14 cathode tablets. Each of Cells Ex. 1-4 utilize anode tablets having a “cup & lid” design as shown and described in FIG. 4C. Each of Cells Ex. 5-6 utilize anode tablets having a “sleeve” design as shown and described in FIGS. 4A-4B. Cell Ex. 5 includes a zinc foil attached to the zinc current collector nail, as described in detail in U.S. application Ser. No. 15/057,639, filed on Nov. 21, 2022, the contents of which are incorporated herein by reference in their entirety. FIG. 6 demonstrates the volume of components within the electrochemical cells and the maximum diffusion length of active materials within the anode and cathode, and the interfacial area between anode and cathodes within each electrochemical cell. As shown, each of Cells Ex. 1-6 have anode diffusion lengths that are less than the anode diffusion length of the conventional bobbin cell (the values shown in the table are provided as a percentage comparison with the conventional bobbin cell design). Each of Cells Ex. 1 and Ex. 3-6 have cathode diffusion lengths that are less than the conventional bobbin cell design. Moreover, each of Cells Ex. 1 and Ex. 3-6 have higher interfacial surface areas as compared with the conventional bobbin cell design. Cell Ex. 2 has a higher cathode capacity and anode capacity as compared with the conventional bobbin cell design.

### Example Methods of Making Alkaline Electrochemical Cells With Stacked Electrodes

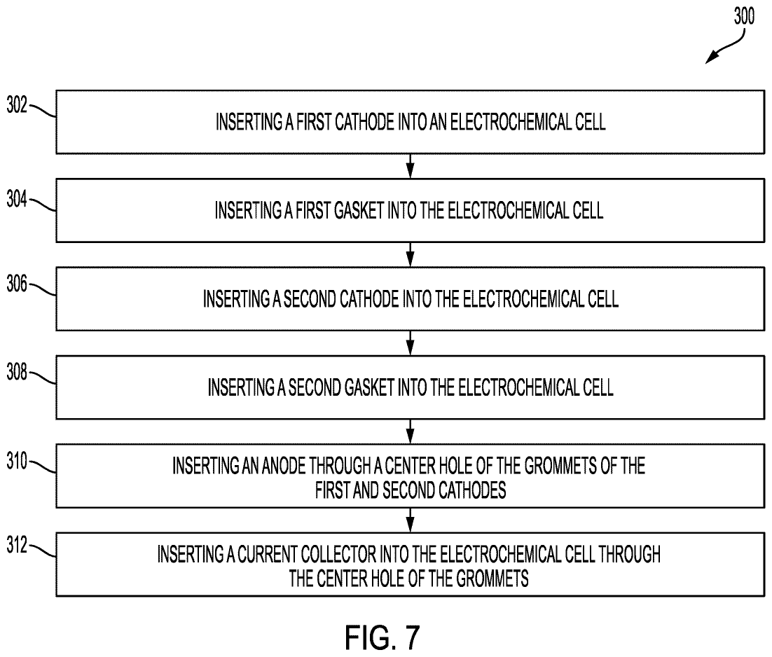

FIG. 7 is a flowchart illustrating an example method of manufacturing alkaline electrochemical cells with stacked electrodes. These example methods are provided to manufacture electrochemical cells 200 having stacked electrodes as discussed herein.

As shown in FIG. 7, a method of manufacturing 300 may include a step 302 of inserting a first cathode (including the separator material, the cathode tablet, and the male and female grommets) into an electrochemical cell. In some embodiment, the first cathode may be assembled prior to being inserted into the electrochemical cell. The cathode tablet may comprise cathode material that is pressed into the final shape of the cathode tablet. The separator material may be paper disks that are placed on opposite sides of the cathode tablet. In some embodiments, the cathode tablet and the separators may be annular and have center holes. The male and female grommet may be inserted into the center holes of the annular cathode tablet and the separator material. The male and female grommets in conjunction with the separators may seal the first cathode to prevent seeping of anode material into contact with the cathode. When the first cathode is inserted into the electrochemical cell in step 302, the active material of the cathode tablet may contact the can, such that the can operates as a cathode current collector. An additional step, prior to insertion of the cathode into the electrochemical cell, may include applying a sealant to the separator material and/or the grommet of the cathode to further seal the cathode.

The method 300 may also include a step 304 of inserting an annular gasket into the electrochemical cell, where the gasket is configured to receive anode material within an open interior thereof. In some embodiments, when the gasket is inserted into the electrochemical cell, a bottom edge of the gasket may press against the top surface of the first cathode. The gasket may thereby pinch the separator material between the gasket and the cathode tablet, which may prevent anode material from leaking into the cathode (or vice versa). The gasket may frictionally engage the interior wall of the can and engage with the cathode such that the cathode is pressed against the bottom of the can. In some embodiments, the top edge of the gasket may support a second cathode that, as discussed later, may be inserted into the cell. When the second cathode is inserted into the cell, the separator material of the second cathode may be pinched between the cathode tablet and the gasket, again keeping any anode material from leaking into the cathode (or vice versa).

The method 300 may include a step 306 of providing a second cathode (with separator material) into the electrochemical cell. As with the first cathode, the second cathode may be assembled prior to insertion into the electrochemical cell, similar to how the first cathode was assembled. The method 300 may include a step 308 of inserting a second gasket into the electrochemical cell, with the second gasket configured to receive anode material. The insertion of the second gasket in step 308 may be substantially the same as the insertion of the first gasket in step 304. Steps 302, 304, 306, and 308 may be repeated as desired for insertion of additional cathodes and gaskets.

The method 300 includes a step 310 of providing (e.g., extruding) the anode through the center hole of the grommets and into the electrochemical cell. As discussed herein, because the center holes of the grommets are electrically insulated from the cathode material, anode material can be extruded through the center holes of the cathodes without risk of creating short-circuits. The method 300 may then include a step 312 of inserting an anode current collector (e.g., a nail) into the electrochemical cell through the aligned center holes of the grommets. Inserting the anode current collector though the center holes of the cathodes enables the anode current collector to be in electrical contact with anode material in each of the anode material layers within the stacked electrode cell. In some embodiments, the method 300 may allow electrolyte shot to be inserted into the cell 200 while still allowing trapped air to escape from the cell 200.

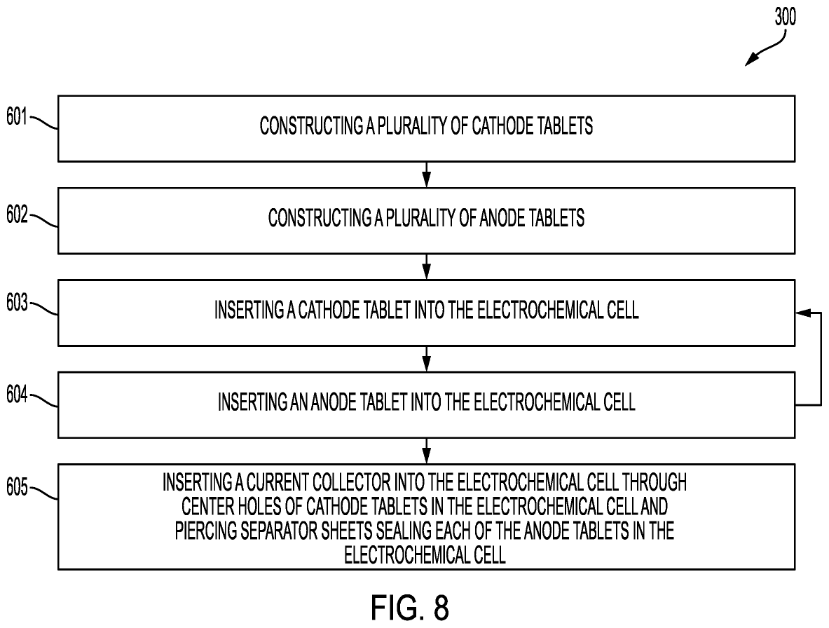

FIG. 8 is a flowchart showing a second example method of manufacturing an electrochemical cell with stacked electrodes.

As shown in FIG. 8, the cathode tablets and anode tablets are constructed prior to insertion into the electrochemical cell. Specifically, step 601 states that a plurality of cathode tablets are constructed, and step 602 states that a plurality of anode tablets are constructed. The cathode tablets are constructed by forming a cathode disk having a central throughole. The cathode disks can be formed by pressing the cathode material into the desired shape of the cathode disk. Separator sheets are placed on opposite planar ends of the cathode disk while maintaining an exposed cylindrical sidewall of the cathode disk. Insulating material grommets (and/or a sleeve), as illustrated in FIGS. 3A-3B, are then inserted into the central throughhole to insulate the cathode material from the anode current collector nail that is later inserted through the central throughhole, and to secure the separator material onto the planar surfaces of the cathode tablets. As discussed above, the grommets (and/or sleeve) are secured to one another to secure the separator material onto the surface of the cathode material.

With reference to Step 602, the anode tablets are constructed by placing anode material inside of a sealed anode tablet as shown in FIGS. 4A-4C. In embodiments where the anode material is a flowable material (e.g., a gel), the anode material may be extruded or otherwise provided into an anode sleeve 221 having a sealed end (e.g., with separator material sealed onto one end of the sleeve 221). Once the anode material has been provided into the sleeve 221, the open end of the sleeve may be sealed by securing a separator onto the open end of the sleeve to create an entirely sealed anode tablet.

With reference again to FIG. 8, the electrochemical cell is constructed by stacking cathode and anode tablets inside the electrochemical cell. As shown in Step 603, a cathode tablet is first inserted into the electrochemical cell, followed by an anode tablet as shown in Step 604. Steps 603-604 are repeated until a desired number of cathode tablets and anode tablets are inserted into the electrochemical cell. It should be understood that although FIG. 8 indicates that a cathode tablet is inserted into the electrochemical cell first, it should be understood that an anode tablet may be inserted first in other embodiments.

Once a desired number of assembled cathode tablets and anode tablets have been inserted into the electrochemical cell, an anode current collector nail is inserted through a center of the electrodes as shown at Step 605. The current collector nail extends through a center throughhole in the cathode tablets, within the grommets and/or sleeves of the cathode tablets to electrically insulate the current collector nail from the cathode active material. The current collector nail pierces the sealed anode tablets by extending through the separator sheets on each side of the anode tablets. The current collector nail extends from the top of the electrochemical cell and extends at least into the first-inserted anode tablet in the cell (the anode tablet that is lowest in the electrochemical cell). for those electrochemical cells having a cathode tablet on the bottom interior surface of the electrochemical cell, the cathode tablet does not need to extend into an insulated center opening of the bottom-most cathode tablet. In such embodiments, a distal end of the anode current collector nail is positioned within the lowest anode tablet in the electrochemical cell.

The open top end of the electrochemical cell is then sealed with the closure assembly comprising a gasket and a negative terminal in electrical connection with the anode current collector.

While embodiments have been illustrated and described in detail above, such illustration and description are to be considered illustrative or exemplary and not restrictive. It will be understood that changes and modifications may be made by those of ordinary skill within the scope and spirit of the following claims. Embodiments include any combination of features from different embodiments described above and below.

The embodiments are additionally described by way of the following illustrative non-limiting examples that provide a better understanding of the embodiments and of its many advantages. The following examples are included to demonstrate preferred embodiments. It should be appreciated by those of skill in the art that the techniques disclosed in the examples which follow represent techniques used in the embodiments to function well in the practice of the embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the embodiments.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

1. An electrochemical cell comprising:
a container having a closed bottom end and an open top end;
a closure assembly secured to and closing the open top end of the container;
a stack comprising two or more tablet-shaped electrodes disposed within the container, wherein the two or more tablet-shaped electrodes comprise a set of one or more first electrodes and a set of one or more second electrodes, and
wherein the one or more first electrodes and the one or more second electrodes alternate within the stack;
a set of separators comprising one or more separators disposed between each electrode within the stack;
an electrolyte solution disposed within the container; and
a current collector disposed within the container.

2. The electrochemical cell of claim 1, wherein the one or more separators comprises at least one first separator and at least one second separator, and wherein the at least one first separator has a different composition than the at least one second separator.

3. The electrochemical cell of claim 1, wherein the one or more first electrodes are anodes comprising a zinc material.

4. The electrochemical cell of claim 3, wherein the one or more second electrodes are cathodes comprising a manganese dioxide material.

5. The electrochemical cell of claim 4, comprising a second electrode positioned on a bottom end of the stack, adjacent the closed bottom end of the container.

6. The electrochemical cell of claim 5, comprising a second electrode positioned on a top end of the stack, adjacent the open top end of the container.

7. The electrochemical cell of claim 1, wherein each of the one or more second electrodes defines a center opening extending therethrough and each of the one or more second electrodes further comprises an insulating sleeve lining the center opening; and
wherein the current collector is a current collector nail extending through a center of the insulating sleeve.

8. The electrochemical cell of claim 7, wherein at least one of the one or more separators are secured to each of the one or more first electrodes and wherein the current collector nail extends through a center of the at least one separator secured to each of the one or more first electrodes to electrically connect with active material of the one or more first electrodes.

9. The electrochemical cell of claim 8, wherein each of the one or more first electrodes comprises a gasket electrically insulating the active material of the one or more first electrodes from the container, and wherein the at least one of the one or more separators are secured to the gasket.

10. The electrochemical cell of claim 7, wherein each of the one or more second electrodes comprises at least one separator; and
wherein the insulating sleeve of each of the one or more second electrodes comprises one or more grommets securing the at least one separator of each second electrode.

11. An anode comprising:
an anode active material composition;
an insulating gasket having open ends, wherein the insulating gasket surrounds the anode active material; and
an ionically-permeable separator disk secured onto each of the open ends of the insulating gasket to seal the anode active material within the insulating gasket.

12. The anode of claim 11, wherein the anode active material comprises:
particulate zinc suspended within an electrolyte gel;
particulate zinc oxide; and
dissolved zinc oxide.

13. The anode of claim 11, wherein the insulating gasket comprises a polymeric material.

14. The anode of claim 11, wherein the insulating gasket comprises:
a cylindrical sleeve having a first open end and an opposite second open end;
a first grommet secured onto the first open end, wherein a first separator is secured onto the first grommet; and
a second grommet secured onto the second open end, wherein a second separator is secured onto the second grommet.

15. The anode of claim 14, wherein the first separator is adhered onto the first grommet and the second separator is adhered onto the second grommet.

16. A cathode comprising:
a cathode active material composition formed in an annular shape defining a center opening extending therethrough;
a first ion-permeable separator sheet on a first side of the cathode active material composition;
a second ion-permeable separator sheet on a second side of the cathode active material composition;
an insulating sleeve positioned within the center opening, wherein:
a first end of the insulating sleeve extends beyond the first ion-permeable separator sheet and secures the first ion-permeable separator sheet onto the first side of the cathode active material composition; and
a second end of the insulating sleeve extends beyond the second ion-permeable separator sheet and secures the second ion-permeable separator sheet onto the second side of the cathode active material composition.

17. The cathode of claim 16, wherein the first ion-permeable separator sheet and the second ion-permeable separator sheet are planar and a sidewall of the cathode active material composition extending between the first side and the second side is exposed.

18. The cathode of claim 16, wherein the insulating sleeve comprises a first grommet and a second grommet secured to the first grommet within the cylindrical open center of the cathode active material composition.
